(19) United States
(12) Patent Application Publication
(10) Pub. No.: US 2026/0185763 A1
(43) Pub. Date: Jul. 2, 2026

(54) REFRIGERATION CYCLE DEVICE

(71) Applicant: DENSO CORPORATION, Kariya-city (JP)

(72) Inventors: Daiki KATO, Kariya-city (JP); Yuichi KAMI, Kariya-city (JP)

(21) Appl. No.: 19/544,524

(22) Filed: Feb. 19, 2026

Related U.S. Application Data
(63) Continuation of application No. PCT/JP2024/023311, filed on Jun. 27, 2024.

(30) Foreign Application Priority Data
Aug. 22, 2023 (JP) 2023-134626

(51) Int. Cl. F25B 49/02; F25B 29/00

(52) U.S. Cl. CPC F25B 49/022; F25B 29/00; F25B 2600/025

(57) ABSTRACT

A refrigeration cycle device includes a compressor, a heat radiator that dissipates heat from the refrigerant discharged from the compressor, a first pressure reduction unit and a second pressure reduction unit that reduce a pressure of the refrigerant heat-dissipated in the heat radiator, a first evaporator that evaporates the refrigerant decompressed in the first pressure reduction unit, a second evaporator that evaporates the refrigerant decompressed in the second pressure reduction unit, and a controller configured to control the compressor at a rotation speed equal to or higher than a minimum rotation speed. The controller controls an amount of heat absorption of the refrigerant in the second evaporator so that temperature of the first evaporator approaches a target evaporator temperature when a difference between the rotation speed of the compressor and the minimum rotation speed is within a predetermined range.

### CROSS REFERENCE TO RELATED APPLICATION

The present application is a continuation application of International Patent Application No. PCT/JP2024/023311 filed on Jun. 27, 2024, which designated the U.S. and claims the benefit of priority from Japanese Patent Application No. 2023-134626 filed on Aug. 22, 2023. The entire disclosures of all of the above applications are incorporated herein by reference.

### TECHNICAL FIELD

The present disclosure relates to a refrigeration cycle device including multiple evaporators.

### BACKGROUND

Conventionally, in a refrigeration cycle device, a minimum rotation speed for a control of a rotation speed of a compressor may be set. However, when the compressor is operated intermittently at the minimum rotation speed, the pressure of a high-pressure refrigerant fluctuates, which impairs the stability of the control of the refrigeration cycle device.

### SUMMARY

A refrigeration cycle device according to an aspect of the present disclosure includes a compressor, a heat radiator, a first pressure reduction unit, a second pressure reduction unit, a first evaporator, a second evaporator, and a controller including at least one of (i) a circuit and (ii) a processor with a memory storing computer program code executable by the processor. The compressor is configured to suck, compress, and discharge a refrigerant. The heat radiator is configured to radiate heat from the refrigerant discharged from the compressor. The first pressure reduction unit and the second pressure reduction unit are configured to reduce a pressure of the refrigerant heat-radiated in the heat radiator. The first evaporator is configured to evaporate the refrigerant decompressed in the first pressure reduction unit. The second evaporator is configured to evaporate the refrigerant decompressed in the second pressure reduction unit.

The controller is configured to control operation of the compressor at a rotation speed equal to or higher than a minimum rotation speed, and to control an amount of heat absorption of the refrigerant in the second evaporator and to cause a temperature of the first evaporator to approach a target evaporator temperature, when a difference between the rotation speed of the compressor and the minimum rotation speed is within a predetermined range.

For example, in a case where the difference between the rotation speed of the compressor and the minimum rotation speed is within the predetermined range, (i) the controller may increase the amount of heat absorption of the refrigerant in the second evaporator when the temperature of the first evaporator is lower than the target evaporator temperature, and (ii) the controller may decrease the amount of heat absorption of the refrigerant in the second evaporator when the temperature of the first evaporator is higher than the target evaporator temperature, to bringing the temperature of the first evaporator closer to the target evaporator temperature.

### BRIEF DESCRIPTION OF THE DRAWINGS

The above object and other objects, features, and advantages of the present disclosure will become more apparent from the following detailed description with reference to the accompanying drawings. In the drawings:

FIG. 1 is an overall configuration diagram of a refrigeration cycle device according to a first embodiment;

FIG. 2 is a block diagram of an electrical control unit of a vehicle air conditioner according to the first embodiment;

FIG. 3 is a schematic configuration diagram of an indoor air conditioning unit according to the first embodiment;

FIG. 4 is a Mollier diagram illustrating normal control of the refrigeration cycle device according to the first embodiment;

FIG. 5 is a Mollier diagram illustrating a chiller heat absorption amount increase control in the refrigeration cycle device according to the first embodiment;

FIG. 6 is an overall configuration diagram of a refrigeration cycle device in a first example according to a second embodiment;

FIG. 7 is an overall configuration diagram of a refrigeration cycle device in a second example according to the second embodiment; and

FIG. 8 is an overall configuration diagram of a refrigeration cycle device according to a third embodiment.

### DETAILED DESCRIPTION

A refrigeration cycle device may use a low-pressure refrigerant in a refrigerant cycle to perform air-conditioning of a vehicle cabin and to cool a battery. Specifically, the refrigeration cycle device is equipped with an indoor evaporator that cools the air to be blown into the vehicle cabin by exchanging heat with a low-pressure refrigerant, and is also equipped with a refrigerant passage line as a battery cooling unit that absorbs heat from the battery into the low-pressure refrigerant.

Further, in the refrigeration cycle device, an indoor condenser heats the air cooled by the indoor evaporator by heat exchange with a high-pressure refrigerant in the refrigerant cycle, thereby utilizing heat of the high-pressure refrigerant to the air-conditioning of the vehicle cabin and achieving a dehumidifying-heating.

In the refrigeration cycle device, a minimum rotation speed for a control of a rotation speed of a compressor may be set. This is because the compressor cannot be driven at a rotation speed lower than the minimum rotation speed due to the drive torque. When it is desired to operate the compressor at a speed lower than the minimum rotation speed, operation corresponding to a rotation speed lower than the minimum rotation speed can be achieved by operating the compressor intermittently, i.e., by repeatedly starting and stopping the compressor.

In the above-described refrigeration cycle device, when the rotation speed of the compressor lowers, a flow rate of the refrigerant in the indoor evaporator (in other words, a first evaporator) lowers, and the temperature of the indoor evaporator rises. Therefore, when temperature of the indoor evaporator is too low even when the compressor rotation speed has been lowered to the minimum rotation speed, temperature of the indoor evaporator can be raised by an intermittent operation of the compressor, in which the operation of the compressor is repeatedly started or stopped.

For example, when the load on the indoor evaporator is low and the heating load is low, the temperature of the indoor evaporator may drop to a frost zone even when the compressor rotation speed is lowered to the minimum rotation speed. However, by operating the compressor intermittently, it is possible to prevent the temperature of the indoor evaporator from dropping to the frost zone.

When the compressor is operated intermittently, the pressure of the high-pressure refrigerant fluctuates, which impairs the stability of the control of the refrigeration cycle device. For example, in the refrigeration cycle device that utilizes the heat of a high-pressure refrigerant for air conditioning, temperature of the blown air fluctuates, thereby impairing the comfort of the air conditioning.

In view of the above, it is an object of the present disclosure to maintain temperature of a first evaporator without stopping a compressor.

A refrigeration cycle device according to an exemplar of the present disclosure includes a compressor, a heat radiator, a first pressure reduction unit, a second pressure reduction unit, a first evaporator, a second evaporator, a compressor control unit, and a heat-absorption amount control unit. The compressor is configured to suck, compress, and discharge a refrigerant. The heat radiator is configured to radiate heat from the refrigerant discharged from the compressor. The first pressure reduction unit and the second pressure reduction unit are configured to reduce a pressure of the refrigerant heat-radiated in the heat radiator. The first evaporator is configured to evaporate the refrigerant decompressed in the first pressure reduction unit. The second evaporator is configured to evaporate the refrigerant decompressed in the second pressure reduction unit.

The compressor control unit is configured to control operation of the compressor at a rotation speed equal to or higher than a minimum rotation speed. The heat-absorption amount control unit is configured to control an amount of heat absorption of the refrigerant in the second evaporator and to cause a temperature of the first evaporator to approach a target evaporator temperature, when a difference between the rotation speed of the compressor and the minimum rotation speed is within a predetermined range.

By controlling the amount of heat absorption of the refrigerant in the second evaporator, the amount of heat absorption of the refrigerant in the first evaporator changes, and the temperature of the first evaporator changes, thereby bringing the temperature of the first evaporator closer to the target evaporator temperature. Therefore, the temperature of the first evaporator can be controlled at a temperature without stopping the compressor.

Hereinafter, embodiments for implementing the present disclosure will be described with reference to drawings. In each embodiment, parts corresponding to those described in preceding embodiment(s) are assigned with the same reference numerals, and redundant explanations may be omitted. In cases where only part of the configuration is described in each embodiment, the other parts of the configuration may be implemented by applying the previously described embodiments. Not only combinations of parts explicitly stated as being combinable in each embodiment, but also partial combinations of embodiments that are not explicitly mentioned can be implemented, provided that there is no particular hindrance to such combinations.

### First Embodiment

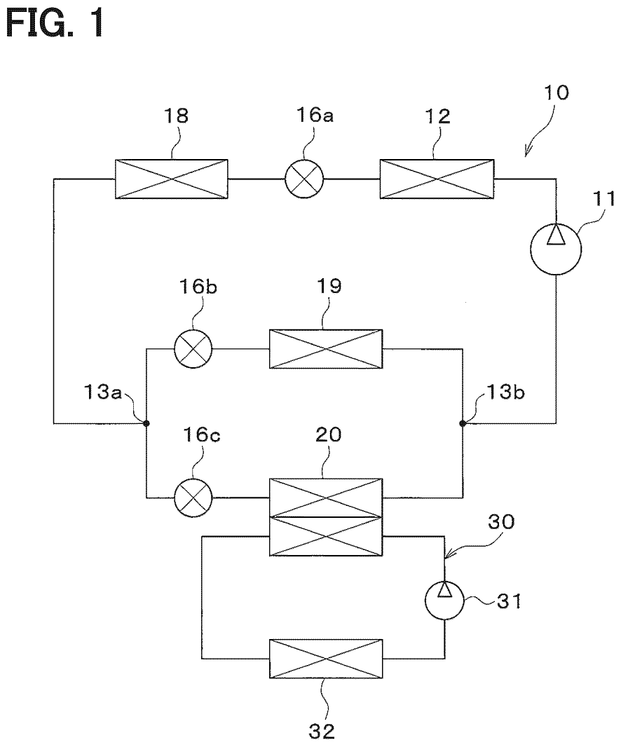

The first embodiment of a refrigeration cycle device 10 according to the present disclosure will be described with reference to FIGS. 1 to 5. The refrigeration cycle device 10 is applied to an air conditioner (e.g., a vehicle air conditioner) mounted on an electric vehicle. The electric vehicle is a vehicle which uses driving force from an electric motor for traveling. The vehicle air conditioner of the present embodiment conditions the air inside a vehicle cabin, which is a space to be air-conditioned, in an electric vehicle.

The refrigeration cycle device 10 cools or heats air to be blown into a vehicle cabin in the vehicle air conditioner. Therefore, the object to be temperature-adjusted (in other words, a heat utilization target) of the refrigeration cycle device 10 is air.

The refrigeration cycle device 10 uses an HFO refrigerant (specifically, R1234yf) as the refrigerant. The refrigeration cycle device 10 constitutes a vapor compression type subcritical refrigeration cycle in which the pressure of the high-pressure refrigerant discharged from the compressor 11 shown in FIG. 1 does not exceed a critical pressure of the refrigerant. The refrigerant has, mixed therein, refrigeration oil (specifically, PAG oil) for lubricating the compressor 11. A part of the refrigeration oil circulates in the cycle together with the refrigerant.

The compressor 11 sucks, compresses, and discharges the refrigerant in the refrigeration cycle device 10. The compressor 11 is disposed in a drive device compartment on a front side of the vehicle cabin. The drive device compartment forms a space where at least a part of a drive device (e.g., the electric motor) for outputting the driving force for traveling is disposed.

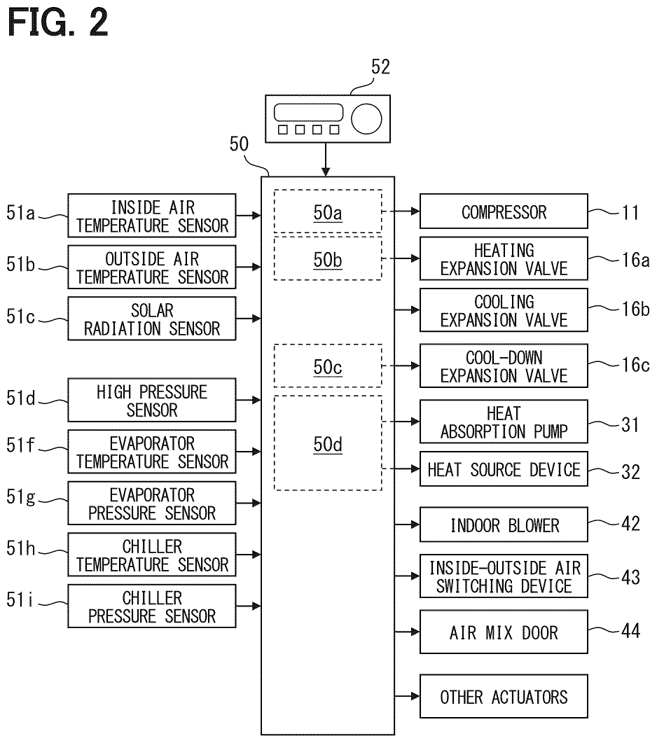

The compressor 11 is an electric compressor that rotationally drives a fixed capacity type compression mechanism that has a fixed discharge capacity by an electric motor. The rotation speed (i.e., refrigerant discharge pressure) of the compressor 11 is controlled by a control signal output from a control device 50 shown in FIG. 2.

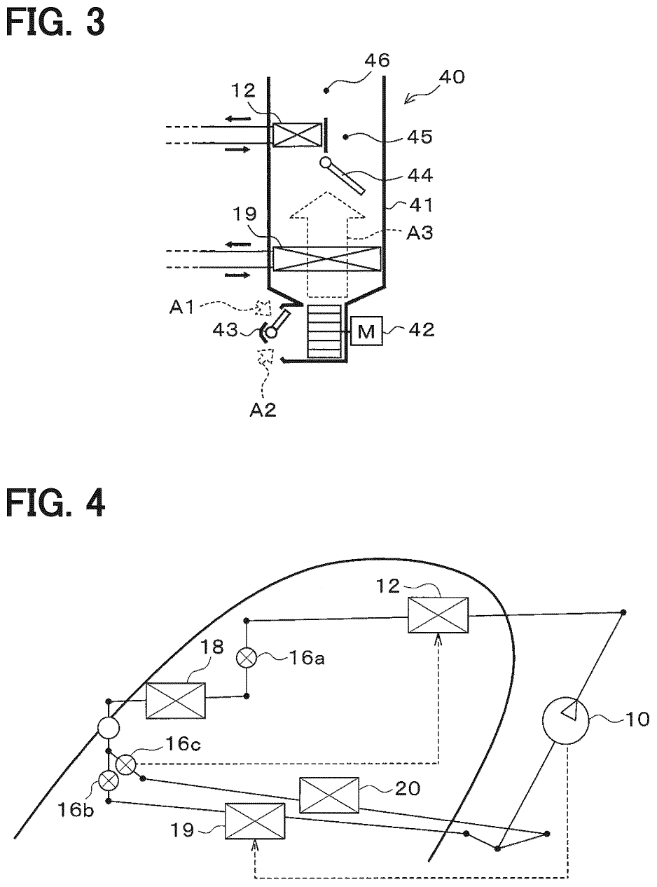

As shown in FIG. 1, a discharge port of the compressor 11 is connected to a refrigerant inlet side of an indoor condenser 12. As shown in FIG. 3, the indoor condenser 12 is disposed in a casing 41 of an indoor air conditioning unit 40. The indoor condenser 12 is a heat radiator that exchanges heat between the high-pressure refrigerant discharged from the compressor 11 and air, thereby dissipating heat from the high-pressure refrigerant. In other words, the indoor condenser 12 is a heat utilization unit that uses the high-pressure refrigerant discharged from the compressor 11 as a heat source and radiates heat to the air, which is the heat utilization target.

As shown in FIG. 1, a refrigerant outlet port of the indoor condenser 12 is connected to the refrigerant inlet side of an outdoor heat exchanger 18 via a heating expansion valve 16a. The heating expansion valve 16a is a pressure reduction unit that reduces the pressure of the refrigerant that has flowed out from the indoor condenser 12 and adjusts the flow rate of the refrigerant that flows downstream.

The heating expansion valve 16a is an electrically operated variable throttle mechanism having (i) a valve element configured to change a throttle opening degree, and (ii) an electrically operated actuator (specifically, a stepping motor) that displaces the valve element. The operation of the heating expansion valve 16a is controlled by a control signal (specifically, a control pulse) output from the control device 50.

The heating expansion valve 16a has (i) a fully open function, which functions as a simple refrigerant passage without performing any flow rate adjustment or refrigerant pressure reduction function when the valve is fully opened, and (ii) a fully closed function, which blocks the refrigerant passage when the valve is fully closed.

The refrigeration cycle device 10 includes a cooling expansion valve 16b and a cool-down expansion valve 16c. The cooling expansion valve 16b and the cool-down expansion valve 16c have the same basic configuration as the heating expansion valve 16a. The heating expansion valve 16a and the like may be formed by combining a variable throttle mechanism that does not have a fully closed function with an on-off valve.

The outdoor heat exchanger 18 is a heat exchanger that exchanges heat between the refrigerant flowing out from the heating expansion valve 16a and outside air blown by an outside air fan (not shown). The outdoor heat exchanger 18 is a heat radiator that exchanges heat between the high-pressure refrigerant discharged from the compressor 11 and outside air, thereby dissipating heat from the high-pressure refrigerant. In other words, the outdoor heat exchanger 18 is a heat discharging unit (in other words, a discharging heat exchanger) that discharges heat from the high-pressure refrigerant discharged from the compressor 11 to the outside air. The heating expansion valve 16a is a heat-discharging pressure reduction unit that reduces the pressure of the refrigerant flowing into the outdoor heat exchanger 18.

The outdoor heat exchanger 18 is disposed on a front side of the drive device compartment. Therefore, when the vehicle travels, a traveling wind can be applied to the outdoor heat exchanger 18.

The refrigerant outlet port of the outdoor heat exchanger 18 is connected to an inlet side of a first three-way joint 13a having three inlet-outlet ports that communicate with each other. As such a three-way joint, a three-way joint formed by joining multiple pipes, or a three-way joint formed by providing multiple refrigerant passages in a metal block or a resin block may be adopted.

The first three-way joint 13a has three inlet-outlet ports, one of which is used as an inlet port and the other two are used as outlet ports, and serves as a branching unit that branches a flow of refrigerant that has flowed in from one inlet port.

One outlet port of the first three-way joint 13a is connected to an inlet side of the cooling expansion valve 16b. The other outlet port of the first three-way joint 13a is connected to an inlet side of the cool-down expansion valve 16c.

The cooling expansion valve 16b is a first pressure reduction unit that reduces the pressure of the refrigerant that has flowed out from the outdoor heat exchanger 18 and adjusts the flow rate of the refrigerant that flows downstream.

The outlet port of the cooling expansion valve 16b is connected to a refrigerant inlet side of an indoor evaporator 19. The indoor evaporator 19 is disposed within the casing 41 of the indoor air conditioning unit 40. The indoor evaporator 19 is a first evaporator that evaporates low-pressure refrigerant decompressed by the cooling expansion valve 16b by heat exchange with air blown by an indoor blower 42. The indoor evaporator 19 is an air cooling unit that cools the air by evaporating low-pressure refrigerant and exerting a heat absorption effect.

A refrigerant outlet port of the indoor evaporator 19 is connected to one inlet port of a second three-way joint 13b. The basic configuration of the second three-way joint 13b is similar to that of the first three-way joint 13a. The second three-way joint 13b is a merging part where two of the three inlet-outlet ports are used as inlet ports and one of the three inlet-outlet ports is used as an outlet port, and where the flows of refrigerant flowing in from the two inlet ports are merged together.

The cool-down expansion valve 16c is a second pressure reduction unit that reduces the pressure of the refrigerant that has flowed out from the outdoor heat exchanger 18 and adjusts the flow rate of the refrigerant that flows downstream. The outlet port of the cool-down expansion valve 16c is connected to an inlet side of a chiller 20.

The chiller 20 is a second evaporator that evaporates the low-pressure refrigerant decompressed by the cool-down expansion valve 16c by heat exchange with a cooling water (in other words, a heat absorption heat medium) circulating in a heat absorption cooling water circuit 30 (in other words, a heat-absorption heat medium circuit). The chiller 20 is a heat medium cooling unit that cools the cooling water by evaporating the low-pressure refrigerant and exerting a heat absorption effect. The refrigerant outlet port of the indoor evaporator 19 is connected to a suction port side of the compressor 11 via the second three-way joint 13b.

The heat absorption cooling water circuit 30 is provided with a heat absorption pump 31, the chiller 20, a heat source device 32, and the like. The heat absorption pump 31 is an electric pump that pressure-feeds the cooling water circulating through the heat absorption cooling water circuit 30 to a cooling water flow path of the heat source device 32. The heat source device 32 is a heat supply unit that supplies heat to the cooling water. For example, the heat source device 32 is an in-vehicle device that generates heat, such as an electric heater, a powertrain device and the like.

As the cooling water, a solution containing ethylene glycol, dimethylpolysiloxane, nanofluid, etc., an antifreeze solution, a water-based liquid medium containing alcohol, etc., a liquid medium containing oil, etc., etc. can be used.

Next, the indoor air conditioning unit 40 will be described with reference to FIG. 3. The indoor air conditioning unit 40 is a unit in the vehicle air conditioner that blows out air that has been appropriately temperature-adjusted to an appropriate position in the vehicle cabin. The indoor air conditioning unit 40 is disposed inside an instrument panel at a front-most end of the vehicle cabin.

The indoor air conditioning unit 40 has the casing 41 that forms an air passage. The indoor blower 42, the indoor evaporator 19, the indoor condenser 12, and the like are arranged in an air passage formed within the casing 41. The casing 41 is made of a resin (for example, polypropylene) that has a certain degree of elasticity and is also excellent in strength.

An inside-outside air switching device 43 is disposed on the most upstream side of the air flow of the casing 41. The inside-outside air switching device 43 switches between introducing inside air (i.e., air inside the vehicle cabin) indicated by a dashed arrow A1 in FIG. 3 and outside air (i.e., air outside the vehicle cabin) indicated by a dashed arrow A2 in FIG. 3. The operation of the electric actuator for driving the inside-outside air switching device 43 is controlled by a control signal output from the control device 50.

The indoor blower 42 is disposed downstream of the inside-outside air switching device 43 in an air flow direction. The indoor blower 42 blows the air taken in through the inside-outside air switching device 43 toward the vehicle cabin as indicated by a dashed arrow A3 in FIG. 3. The indoor blower 42 is an electric blower in which a centrifugal multi-blade fan is driven by an electric motor. The rotation speed (i.e., a blowing capacity) of the indoor blower 42 is controlled by a control voltage output from the control device 50.

On the downstream side of the air flow of the indoor blower 42, the indoor evaporator 19 and the indoor condenser 12 are arranged in this written order with respect to the air flow. That is, the indoor evaporator 19 is disposed upstream of the indoor condenser 12 in the air flow direction. A cold air bypass passage 45 is formed in the casing 41 to allow the air that has passed through the indoor evaporator 19 to bypass the indoor condenser 12 and to flow downstream.

An air mix door 44 is disposed downstream of the indoor evaporator 19 in the air flow direction and upstream of the indoor condenser 12 in the air flow direction. The air mix door 44 adjusts, from among air after having passed through the indoor evaporator 19, a ratio of (i) an amount of air passing through the indoor condenser 12 and (ii) an amount of air passing through the cold air bypass passage 45. The operation of the electric actuator for driving the air mix door is controlled by a control signal output from the control device 50.

A mixing space 46 is provided downstream of the air flow of the indoor condenser 12 to mix the air heated by the indoor condenser 12 with the air that has passed through the cold air bypass passage 45 and has not been heated by the indoor condenser 12. Further, an opening hole (not shown) is arranged at the most downstream portion of the air flow of the casing 41, through which the air (air conditioning wind) mixed in the mixing space 46 is blown out into the vehicle cabin.

Therefore, by adjusting the ratio of (i) the amount of air that passes through the indoor condenser 12 to (ii) the amount of air that passes through the cold air bypass passage 45 by using the air mix door 44, the temperature of the air conditioning wind mixed in the mixing space 46 is adjustable. Thus, the temperature of the air blown into the vehicle cabin through each opening is adjustable.

The opening holes include a face opening hole, a foot opening hole, and a defroster opening hole (not shown). The face opening hole is an opening hole for blowing the air conditioning wind toward an upper body of an occupant in the vehicle cabin. The foot opening hole is an opening hole for blowing the air conditioning wind toward feet of the occupant. The defroster opening hole is an opening hole for blowing the air conditioning wind toward an inner surface of window glass on a front surface of the vehicle.

Upstream of these opening holes, there is placed a blow-out mode switching door, which is not illustrated. The blow-out mode switching door is adapted to open and close the respective opening holes, in order to switch the opening hole for blowing the air conditioning wind flows therethrough. The operation of the electric actuator for driving the blow-out mode switching door is controlled by a control signal output from the control device 50.

Next, an outline of an electrical control unit of the vehicle air conditioner will be described with reference to FIG. 2. The control device 50 is configured as a well-known microcomputer including a CPU, a ROM, a RAM, and the like, and peripheral circuits thereof. The control device 50 performs various calculations and processes based on an air conditioning control program stored in the ROM, and controls the operation of the various control target devices 11, 16a to 16c, 31, 32, 42, 43, 44, etc. connected to the output side thereof.

The input side of the control device 50 is connected to various control sensors. The control sensors include an inside air temperature sensor 51a, an outside air temperature sensor 51b, a solar radiation sensor 51c, a high pressure sensor 51d, an evaporator temperature sensor 51f, an evaporator pressure sensor 51g, a chiller temperature sensor 51h, a chiller pressure sensor 51i, and the like.

The inside air temperature sensor 51a is an inside air temperature detection unit that detects an inside air temperature Tr, which is the temperature inside the vehicle cabin. The outside air temperature sensor 51b is an outside air temperature detection unit that detects an outside air temperature Tam, which is the temperature outside the vehicle cabin. The solar radiation sensor 51c is a solar radiation detection unit that detects an amount of solar radiation As irradiated into the vehicle cabin.

The high pressure sensor 51d is a high-pressure pressure detection unit that detects a high-pressure pressure Pd, which is the pressure of the high-pressure refrigerant discharged from the compressor 11.

The evaporator temperature sensor 51f is an evaporator temperature detection unit that detects temperature Te of the indoor evaporator 19 (hereinafter referred to as an evaporator temperature Te), that is, a refrigerant evaporation temperature in the indoor evaporator 19. For example, the evaporator temperature sensor 51f detects temperature of the refrigerant on an outlet port side of the indoor evaporator 19.

The evaporator pressure sensor 51g is an evaporator pressure detection unit that detects a refrigerant evaporation pressure Pe in the indoor evaporator 19. For example, the evaporator pressure sensor 51g detects the pressure of the refrigerant at an outlet port side of the indoor evaporator 19.

The chiller temperature sensor 51h is an outdoor unit temperature detection unit that detects a chiller outdoor unit refrigerant temperature Tc, which is the temperature of the refrigerant flowing through the chiller 20. For example, the chiller temperature sensor 51h detects the temperature of the refrigerant on the outlet port side of the chiller 20.

The chiller pressure sensor 51i is a chiller temperature detection unit that detects a chiller refrigerant pressure Pc, which is the pressure of the refrigerant flowing through the chiller 20. For example, the chiller pressure sensor 51i detects the pressure of the refrigerant on the outlet port side of the chiller 20.

An operation panel 52 arranged near the instrument panel at the front of the vehicle cabin is connected to the input side of the control device 50, and operation signals are input from various operation switches provided on the operation panel 52. The various operation switches provided on the operation panel 52 include an auto switch, an air conditioner switch, an amount of air setting switch, a temperature setting switch, and the like.

The auto switch is an operation switch that sets or cancels an automatic control operation of the refrigeration cycle device 10. The air conditioner switch is an operation switch that requests the indoor evaporator 19 to cool the air. The amount of air setting switch is an operation switch for manually setting an amount of air of the indoor blower 42. The temperature setting switch is an operation switch for setting a target temperature Tset in the vehicle cabin.

The control device 50 of the present embodiment is a one-body unit that includes a control unit for controlling various control target devices connected to the output side of the control device 50. Therefore, the configuration (i.e., hardware and software) for controlling the operation of each of the control target devices constitutes a control unit that controls the operation of each of the control target devices.

For example, a component of the control device 50 that controls the compressor 11 constitutes a compressor control unit 50a. For example, a component of the control device 50 that controls the heating expansion valve 16a constitutes a heat-discharging amount control unit 50b. For example, a component of the control device 50 that controls the cool-down expansion valve 16c constitutes a heat-absorption amount control unit 50c. For example, a component of the control device 50 that controls the heat absorption pump 31 and the heat source device 32 constitutes a heat medium temperature control unit 50d.

Next, the operation of the vehicle air conditioner of the present embodiment having the above-described configuration will be described. The refrigeration cycle device 10 of the present embodiment executes an air conditioning control program stored in advance in the control device 50 to perform air conditioning inside the vehicle cabin. The air conditioning control program is executed when the auto switch on the operation panel 52 is turned on.

The operation of the air conditioning control program will be described in the following. When the air conditioning control program is executed, the control device 50 throttles the heating expansion valve 16a, the cooling expansion valve 16b, and the cool-down expansion valve 16c.

In such manner, in the refrigeration cycle device 10, the refrigerant discharged from the compressor 11 flows through the indoor condenser 12, the heating expansion valve 16a, and the outdoor heat exchanger 18 in this written order. Further, the refrigerant circulates through the cooling expansion valve 16b, the indoor evaporator 19, and the suction port of the compressor 11 in this written order, and also through the cool-down expansion valve 16c, the chiller 20, and the suction port of the compressor 11 in this written order.

That is, a circuit is formed in which the indoor evaporator 19 and the chiller 20 are connected in parallel with respect to the flow of refrigerant flowing out from the outdoor heat exchanger 18.

With such circuit configuration, the control device 50 controls the operation of various control target devices. During normal control, the control device 50 controls the operation of various control target devices as follows. FIG. 4 is an explanatory diagram illustrating the control of various control target devices in a Mollier diagram showing the change in the state of the refrigerant during normal control of the refrigeration cycle device 10.

A discharge capacity of the compressor 11 is controlled so that the evaporator temperature Te (i.e., the refrigerant evaporation temperature in the indoor evaporator 19) detected by the evaporator temperature sensor 51f approaches a target evaporator temperature TEO. The target evaporator temperature TEO is determined based on a target air temperature TAO to be blown into the vehicle cabin by using a control map for a cooling mode, which is stored in advance in the control device 50.

In the control map, a determination is made that the target evaporator temperature TEO rises as the target air temperature TAO rises. Further, the target evaporator temperature TEO is determined to a value within a range (specifically, higher than 1 degree Celsius) that can prevent frost from forming on the indoor evaporator 19.

The target air temperature TAO is a target temperature of the air blown into the vehicle cabin, and is calculated by the following equation.

$$TAO = Kset \times Tset - Kr \times Tr - Kam \times Tam - Ks \times As + C$$

Tset is a cabin temperature set by the temperature setting switch. Tr is cabin temperature detected by the inside air temperature sensor 51a. Tam is outside-cabin temperature outside the vehicle cabin detected by the outside air temperature sensor 51b. As is an amount of solar radiation detected by the solar radiation sensor 51c. Kset, Kr, Kam, and Ks are control gains, and C is a constant for correction.

The throttle opening degree of the cooling expansion valve 16b is controlled so that a degree of superheat of the refrigerant on the outlet port side of the indoor evaporator 19 approaches a target degree of superheat KSH. The degree of superheat of the refrigerant on the outlet port side of the indoor evaporator 19 is calculated from the evaporator temperature Te and the refrigerant evaporation pressure Pe detected by the evaporator pressure sensor 51g. The opening degree of the air mix door 44 is controlled so that the air that has passed through the indoor evaporator 19 entirely flows into the cold air bypass passage 45.

With regard to the cool-down expansion valve 16c, the control device 50 controls it's throttle opening degree so that (i) a blown air temperature TAV of the indoor condenser 12 (in other words, the blown air temperature from the indoor air conditioning unit 40) approaches the target air temperature TAO and (ii) superheat is obtained in the refrigerant on the outlet port side of the chiller 20.

The blown air temperature TAV of the indoor condenser 12 is calculated based on the high-pressure pressure Pd detected by the high pressure sensor 51d, the amount of air of the indoor blower 42, and the temperature of the air flowing into the indoor condenser 12 (in other words, the air temperature Te after passing through the indoor evaporator 19). The blown air temperature TAV of the air blown out from the indoor condenser 12 may be detected by a blown-out air temperature sensor.

The heating expansion valve 16a is maintained at the minimum throttle opening degree in terms of control in order to minimize the amount of heat dissipated from the outdoor heat exchanger 18.

Therefore, the refrigeration cycle device 10 configures a vapor compression refrigeration cycle in which the indoor condenser 12 and the outdoor heat exchanger 18 function as condensers, and the indoor evaporator 19 and the chiller 20 function as evaporators.

In such manner, the air cooled and dehumidified in the indoor evaporator 19 is reheated in the indoor condenser 12 and blown into the vehicle cabin, for performing air conditioning (cooling or dehumidifying-heating) in the vehicle cabin. Further, the refrigerant flowing through the chiller 20 absorbs heat from the heat source device 32 via the cooling water in the heat absorption cooling water circuit 30, thereby allowing the heat source device 32 to be used as a heating source for the air or to cool the heat source device 32.

When it is not necessary to use the heat source device 32 as a heating source for the air, the cool-down expansion valve 16c may be fully closed so that the chiller 20 does not absorb heat.

Here, the rotation speed of the compressor 11 controlled by the control device 50 has a setting of a minimum rotation speed Nmin. The reason of having the setting of the minimum rotation speed Nmin is that the compressor 11 cannot be driven at a rotation speed lower than the minimum rotation speed Nmin due to the drive torque.

In the example of the present embodiment, the minimum rotation speed Nmin is set based on a predetermined rotation speed (for example, 1000 rpm), and is increased or decreased as appropriate taking into consideration an oil return property, a cooling property of the compressor 11, and the like.

When it is desired to operate the compressor 11 at a rotation speed lower than the minimum rotation speed Nmin, an operation equivalent to the rotation speed lower than the minimum rotation speed Nmin is achievable by operating the compressor 11 intermittently, i.e., by repeatedly stopping and starting.

Specifically, when the evaporator temperature Te (i.e., the temperature of the indoor evaporator 19) falls below the target evaporator temperature TEO even when the compressor 11 is driven at the minimum rotation speed Nmin, it becomes necessary to drive the compressor 11 at a rotation speed lower than the minimum rotation speed Nmin to raise the evaporator temperature Te.

However, when the compressor 11 is operated intermittently by repeatedly stopping and starting, the temperature of the blown air (i.e., the temperature of the air after passing through the indoor condenser 12) repeatedly drops and rises, causing the passengers to feel uncomfortable with the air conditioning.

Therefore, in the present embodiment, when the compressor 11 is driven near the minimum rotation speed Nmin, the amount of heat absorbed from the chiller 20 is increased to suppress a drop in the evaporator temperature Te, thereby avoiding intermittent operation of the compressor 11.

Specifically, when a difference between the rotation speed of the compressor 11 and the minimum rotation speed Nmin is within a predetermined range, a chiller heat absorption amount increase control described below is performed. In the example of the present embodiment, the predetermined range is a fixed range that is set in advance, but the predetermined range may be changed depending on a situation.

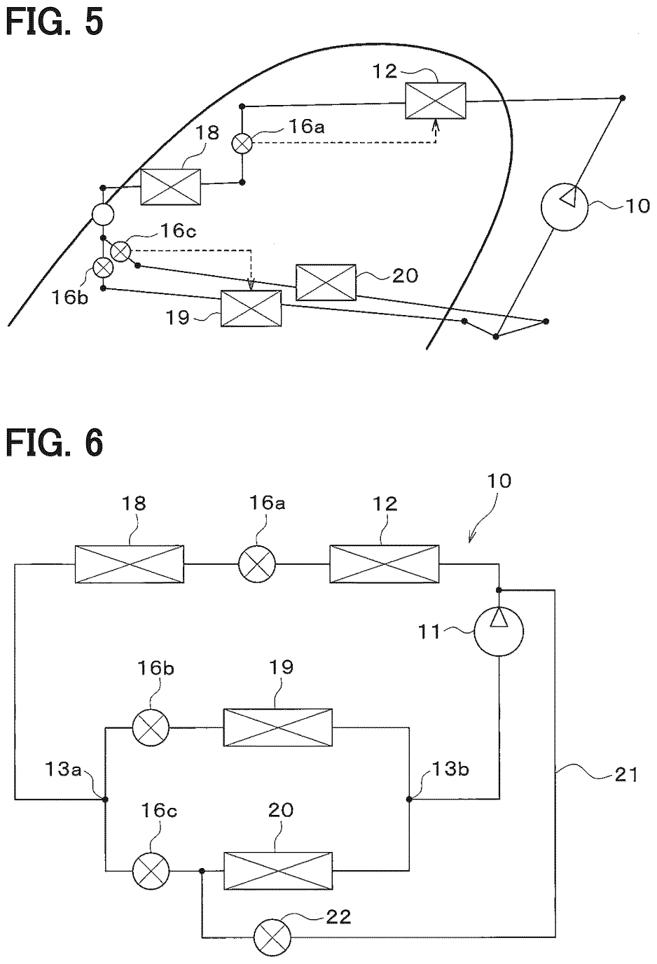

FIG. 5 is an explanatory diagram illustrating the operation of various controlled devices in a Mollier diagram showing the change in the state of the refrigerant when performing a chiller heat absorption amount increase control in the refrigeration cycle device 10.

In the chiller heat absorption amount increase control, the control device 50 maintains the rotation speed of the compressor 11 at the minimum rotation speed Nmin. With regard to the cool-down expansion valve 16c, the control device 50 controls it's throttle opening degree so that (i) the evaporator temperature Te approaches the target evaporator temperature TEO and (ii) the refrigerant on the outlet port side of the chiller 20 is superheated.

In other words, by increasing the throttle opening degree of the cool-down expansion valve 16c and increasing the refrigerant flow rate to the chiller 20 side, the amount of heat absorption by the refrigerant in the chiller 20 increases and the refrigerant flow rate to the indoor evaporator 19 side lowers, thereby reducing the amount of heat absorption by the refrigerant in the indoor evaporator 19, and thus the evaporator temperature Te rises.

At such time, it is preferable to ensure the amount of heat absorption by the refrigerant in the chiller 20 by controlling the amount of heat supplied to the cooling water from the heat source device 32 so that the temperature of the cooling water in the heat absorption cooling water circuit 30 is above a predetermined value. Specifically, the amount of heat supplied to the cooling water from the heat source device 32 can be controlled (i) by controlling the rotation speed of the heat absorption pump 31 to control the flow rate of the cooling water circulating through the heat absorption cooling water circuit 30, or (ii) by controlling the output of the electric heater when the heat source device 32 is an electric heater.

When superheating of the refrigerant on the outlet port side of the chiller 20 cannot be obtained by controlling the cool-down expansion valve 16c alone, it is preferable to control the heat source device 32 so that the temperature of the cooling water in the heat absorption cooling water circuit 30 rises, thereby obtaining superheating of the refrigerant on the outlet port side of the chiller 20.

The opening degree of the heating expansion valve 16a is controlled so that the blown air temperature TAV of the air blown out from the indoor condenser 12 approaches the target air temperature TAO.

As for the cooling expansion valve 16b, the control device 50 controls the throttle opening degree so that the degree of superheat of the refrigerant on the outlet port side of the indoor evaporator 19 approaches the target degree of superheat KSH, as in the normal control.

In such manner, in the refrigeration cycle device 10 during the chiller heat absorption amount increase control, the amount of heat absorbed from the chiller 20 can be increased to suppress a lowering in the evaporator temperature Te, thereby avoiding intermittent operation of the compressor 11.

On the other hand, increasing the amount of heat absorbed from the chiller 20 results in an excessive amount of heat absorption, which may cause the blown air temperature TAV of the indoor condenser 12 to exceed the target air temperature TAO. As a countermeasure, the throttle opening degree of the heating expansion valve 16a is controlled so that the blown air temperature TAV of the indoor condenser 12 approaches the target air temperature TAO, so that the amount of heat discharged from the outdoor heat exchanger 18 can be increased by the amount of heat absorbed from the chiller 20, and it is possible to prevent the blown air temperature TAV of the indoor condenser 12 from exceeding the target air temperature TAO.

In the present embodiment, the control device 50 operates the compressor 11 at a rotation speed equal to or higher than the minimum rotation speed Nmin, and when the difference between the rotation speed of the compressor 11 and the minimum rotation speed Nmin is within a predetermined range, controls the amount of heat absorption of the refrigerant in the chiller 20 so that the temperature Te of the indoor evaporator 19 approaches the target evaporator temperature TEO.

Specifically, when the difference between the rotation speed of the compressor 11 and the minimum rotation speed Nmin is within a predetermined range, (A) in case that the temperature Te of the indoor evaporator 19 is lower than the target evaporator temperature TEO, the control device 50 increases the amount of heat absorption of the refrigerant in the chiller 20, and (B) in case that the temperature Te of the indoor evaporator 19 is higher than the target evaporator temperature TEO, the control device 50 decreases the amount of heat absorption of the refrigerant in the chiller 20, thereby bringing the temperature Te of the indoor evaporator 19 closer to the target evaporator temperature TEO.

According to the above, by controlling the amount of heat absorption of the refrigerant in the chiller 20, the amount of heat absorption of the refrigerant in the indoor evaporator 19 changes and the temperature Te of the indoor evaporator 19 changes, thereby the temperature Te of the indoor evaporator 19 is brought closer to the target evaporator temperature TEO. Therefore, the temperature Te of the indoor evaporator 19 can be maintained without stopping the compressor 11.

In the present embodiment, the control device 50 controls the amount of heat absorption by the refrigerant in the chiller 20 so that the temperature Te of the indoor evaporator 19 approaches the target evaporator temperature TEO, by controlling a pressure reduction amount of the cool-down expansion valve 16c.

In such manner, the amount of heat absorption by the refrigerant in the chiller 20 is reliably controlled, thereby (i) the temperature Te of the indoor evaporator 19 can be reliably brought close to the target evaporator temperature TEO without stopping the compressor 11, and (ii) the temperature Te of the indoor evaporator 19 is reliably maintained.

In the present embodiment, when the difference between the rotation speed of the compressor 11 and the minimum rotation speed Nmin is within a predetermined range, the control device 50 controls the opening degree of the cool-down expansion valve 16c so that the temperature Te of the indoor evaporator 19 approaches the target evaporator temperature TEO.

In such manner, it is possible to more reliably bring the temperature Te of the indoor evaporator 19 closer to the target evaporator temperature TEO, thereby making it possible to more reliably maintain the temperature Te of the indoor evaporator 19.

In the present embodiment, the control device 50 increases the amount of heat discharged by the outdoor heat exchanger 18 as the amount of heat absorption by the refrigerant in the chiller 20 increases. In such manner, it is possible to prevent the amount of heat dissipated into the air in the indoor condenser 12 from becoming excessive, even when the amount of heat absorption by the refrigerant in the chiller 20 is increased to maintain the temperature Te of the indoor evaporator 19. As a result, the temperature of the air blown out from the indoor air conditioning unit 40 can be prevented from becoming too high above desired temperature.

In the present embodiment, the control device 50 increases the amount of heat discharged by the outdoor heat exchanger 18 by reducing the pressure reduction amount in the heating expansion valve 16a as the amount of heat absorption by the refrigerant in the chiller 20 increases. In such manner, the amount of heat dissipated into the air in the indoor condenser 12 is reliably prevented from becoming excessive.

In the present embodiment, when the difference between the rotation speed of the compressor 11 and the minimum rotation speed Nmin is within a predetermined range, the control device 50 controls the amount of heat supplied from the heat source device 32 to the cooling water in the heat absorption cooling water circuit 30 so that the temperature of the cooling water in the heat absorption cooling water circuit 30 is above a predetermined value.

In such manner, it is possible to prevent the amount of heat absorption by the refrigerant in the chiller 20 from becoming insufficient, thereby the temperature Te of the indoor evaporator 19 is reliably brought closer to the target evaporator temperature TEO.

In the present embodiment, the control device 50 controls the rotation speed of the compressor 11 so that the temperature Te of the indoor evaporator 19 approaches the target evaporator temperature TEO. In such manner, it is possible to achieve the above-mentioned effect of maintaining the temperature Te of the indoor evaporator 19 without stopping the compressor 11 in a refrigeration cycle device in which the temperature Te of the indoor evaporator 19 changes significantly when the rotation speed of the compressor 11 changes.

### Second Embodiment

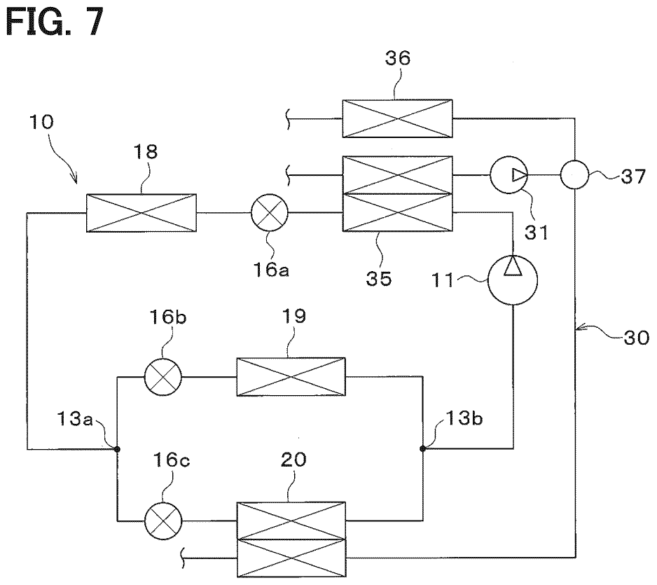

In the above-described first embodiment, the refrigerant circulating through the chiller 20 is configured to absorb heat from the heat source device 32 via the cooling water in the heat absorption cooling water circuit 30. In the second embodiment, as shown in FIGS. 6 and 7, the refrigerant circulating through a chiller 20 is configured to absorb heat from the high-pressure refrigerant in a refrigeration cycle device 10.

In the first example of the second embodiment shown in FIG. 6, a high-pressure refrigerant passage 21 is provided to extend from a discharge port of a compressor 11 to a refrigerant inlet side of a chiller 20. The high-pressure refrigerant passage 21 is a refrigerant introduction unit that is configured to introduce a part of the refrigerant discharged from the compressor 11 into the chiller 20. That is, the high-pressure refrigerant passage 21 is a heat introduction unit that introduces a part of the heat of the refrigerant discharged from the compressor 11 into the chiller 20.

A heat absorption expansion valve 22 is arranged in the high-pressure refrigerant passage 21. The heat absorption expansion valve 22 is a heat-absorbing pressure reduction unit that adjusts the pressure and flow rate of the high-pressure refrigerant in the high-pressure refrigerant passage 21 by adjusting a throttle opening degree of the high-pressure refrigerant passage 21.

In the first example of the second embodiment, a part of the high-pressure refrigerant discharged from the compressor 11 is circulated to the chiller 20 via the high-pressure refrigerant passage 21, thereby enabling the compressor 11 to generate heat effectively.

In the first example of the second embodiment, as in the above-described first embodiment, when the compressor 11 is driven near the minimum rotation speed Nmin, a chiller heat-absorption amount increase control is performed to increase the amount of heat absorbed from the chiller 20, thereby suppressing a lowering in the evaporator temperature Te and avoiding intermittent operation of the compressor 11.

Specifically, when the difference between the rotation speed of the compressor 11 and the minimum rotation speed Nmin is within a predetermined range, the amount of heat absorbed from the chiller 20 is increased by increasing the throttle opening degree of the heat absorption expansion valve 22. In such manner, the amount of heat absorption by the refrigerant in an indoor evaporator 19 decreases. Thus, the evaporator temperature Te can be increased. Therefore, similarly to the above-described embodiment, the temperature Te of the indoor evaporator 19 can be maintained without stopping the compressor 11.

In a second example of the second embodiment shown in FIG. 7, a refrigerant-cooling water heat exchanger 35, a heater core 36, and a three-way valve 37 are arranged in the heat absorption cooling water circuit 30.

The refrigerant-cooling water heat exchanger 35 is a refrigerant-heat medium heat exchanger that exchanges heat between the high-pressure refrigerant discharged from the compressor 11 and the cooling water (in other words, the heat medium) in the heat absorption cooling water circuit 30, thereby dissipating heat from the high-pressure refrigerant. The heater core 36 is a heat exchange unit that exchanges heat between the cooling water heated in the refrigerant-cooling water heat exchanger 35 and the air to heat the air, and is arranged in an air passage formed within the casing 41 of the indoor air conditioning unit 40. The heater core 36 is arranged in parallel with the chiller 20 in a flow of the cooling water of the heat absorption cooling water circuit 30.

The refrigerant-cooling water heat exchanger 35 and the heater core 36 are heat radiators that exchange heat between the high-pressure refrigerant discharged from the compressor 11 and air, thereby dissipating heat from the high-pressure refrigerant. The heater core 36 is a heat utilization unit that uses the high-pressure refrigerant discharged from the compressor 11 as a heat source and dissipates heat via the cooling water to the air, which is the heat utilization target.

The three-way valve 37 is a flow rate ratio adjusting unit that adjusts a flow rate ratio between the flow rate of the cooling water flowing into the chiller 20 and the flow rate of the cooling water flowing into the heater core 36. The operation of the three-way valve 37 is controlled by a control device 50.

The heat absorption cooling water circuit 30 of the second example of the present embodiment is a heat medium introduction unit that introduces a part of the cooling water that has undergone heat exchange in the refrigerant-cooling water heat exchanger 35 into the chiller 20. That is, the heat absorption cooling water circuit 30 of the present embodiment is a heat introduction unit that introduces part of the heat of the refrigerant discharged from the compressor 11 into the chiller 20 via the cooling water.

In the second example of the present embodiment, the cooling water heated in the refrigerant-cooling water heat exchanger 35 is circulated to the chiller 20, so that heat can be effectively generated in the compressor 11.

In the second example of the present embodiment, as in the above-described embodiment, when the compressor 11 is driven near the minimum rotation speed Nmin, a chiller heat absorption amount increase control is performed to increase the amount of heat absorbed from the chiller 20, thereby suppressing a lowering in the evaporator temperature Te and avoiding intermittent operation of the compressor 11.

Specifically, when the difference between the rotation speed of the compressor 11 and the minimum rotation speed Nmin is within a predetermined range, the amount of heat absorbed from the chiller 20 is increased by controlling the three-way valve 37 so that the flow rate ratio of the cooling water flowing into the chiller 20 increases. In such manner, it is possible to achieve the same effects as those of the above-described first embodiment.

In the present embodiment, the control device 50 increases the amount of heat absorption of the refrigerant in the chiller 20 by increasing the amount of heat of the refrigerant introduced from the compressor 11 to the chiller 20.

In such manner, the amount of heat absorption by the refrigerant in the chiller 20 is reliably controlled, thereby (i) the temperature Te of the indoor evaporator 19 can be reliably brought close to the target evaporator temperature TEO without stopping the compressor 11, and (ii) the temperature Te of the indoor evaporator 19 is reliably maintained.

In the first example of the second embodiment described above, when the difference between the rotation speed of the compressor 11 and the minimum rotation speed Nmin is within a predetermined range, the control device 50 increases the amount of heat absorption of the refrigerant in the chiller 20 by increasing the flow rate of the refrigerant introduced from the compressor 11 to the chiller 20.

In such manner, it is possible to more reliably bring the temperature Te of the indoor evaporator 19 closer to the target evaporator temperature TEO, thereby making it possible to more reliably maintain the temperature Te of the indoor evaporator 19.

In the second example of the second embodiment disclosed above, when the difference between the rotation speed of the compressor 11 and the minimum rotation speed Nmin is within a predetermined range, the control device 50 increases the amount of heat absorption of the refrigerant in the chiller 20 by increasing the flow rate of the cooling water in the heat absorption cooling water circuit 30 introduced into the chiller 20.

In such manner, it is possible to more reliably bring the temperature Te of the indoor evaporator 19 closer to the target evaporator temperature TEO, thereby making it possible to more reliably maintain the temperature Te of the indoor evaporator 19.

### Third Embodiment

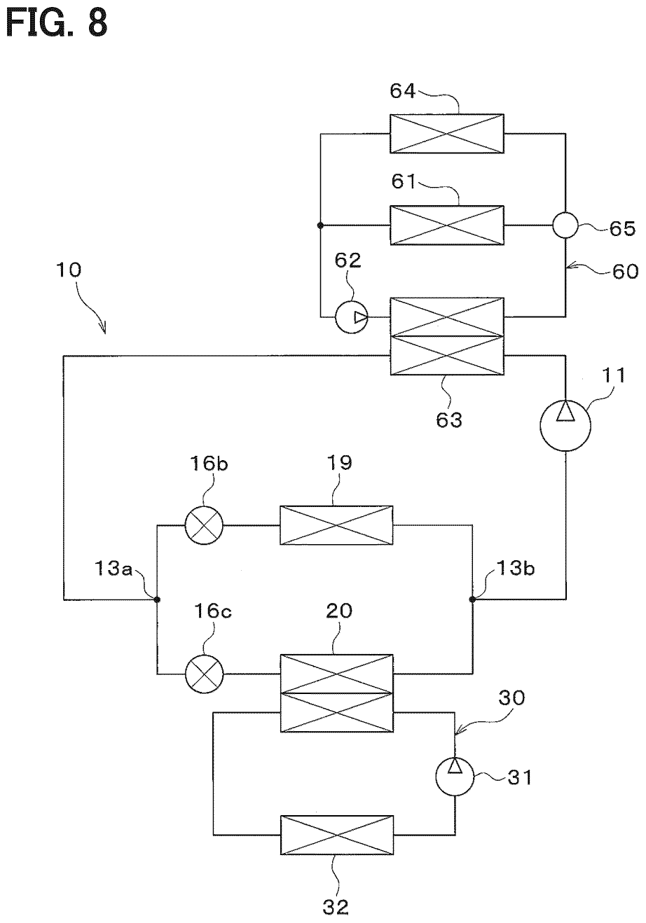

In the first embodiment described above, heat is dissipated to the outside air by the outdoor heat exchanger 18. However, in the present embodiment, heat is dissipated to the outside air by a radiator 61, as shown in FIG. 8.

The radiator 61 is disposed in a heat dissipation cooling water circuit 60 (in other words, a heat-dissipation heat medium circuit). The heat dissipation cooling water circuit 60 includes a heat dissipation pump 62, a refrigerant-cooling water heat exchanger 63, a heater core 64, and a three-way valve 65.

The radiator 61 is a heat exchanger that exchanges heat between the cooling water (in other words, a heat-dissipating heat medium) circulating through the heat dissipation cooling water circuit 60 and the outside air blown by an outside air fan (not shown). The radiator 61 is disposed at a front side in the drive device compartment. Therefore, when the vehicle is traveling, the radiator 61 can be exposed to the wind generated by the travel of the vehicle.

The heat dissipation pump 62 is an electric pump that pumps the cooling water circulating through the heat dissipation cooling water circuit 60. The refrigerant-cooling water heat exchanger 63 is a refrigerant-heat medium heat exchanger that exchanges heat between the high-pressure refrigerant discharged from the compressor 11 and the cooling water (in other words, the heat medium) in the heat dissipation cooling water circuit 60, thereby dissipating heat from the high-pressure refrigerant.

The heater core 64 is a heat exchange unit that heats the air by exchanging heat between the cooling water heated in the refrigerant-cooling water heat exchanger 63 and the air, and is arranged in an air passage formed within the casing 41 of the indoor air conditioning unit 40.

The radiator 61 and the heater core 64 are arranged in parallel with each other in a flow of the cooling water of the heat dissipation cooling water circuit 60.

The radiator 61, the refrigerant-cooling water heat exchanger 63 and the heater core 64 are heat radiators that radiate heat from the high-pressure refrigerant discharged from the compressor 11. The heater core 64 is a heat utilization unit that uses the high-pressure refrigerant discharged from the compressor 11 as a heat source and dissipates heat via the cooling water to the air, which is the heat utilization target. The radiator 61 is a heat discharging unit that discharges heat from the high-pressure refrigerant discharged from the compressor 11 to the outside air via cooling water.

The heater core 64 is a first radiator that radiates heat from the cooling water to the air, which is the heat utilization target. The radiator 61 is a second heat radiator that radiates heat from the cooling water to the outside air (i.e., to an object other than the heat utilization target).

The three-way valve 65 is a flow rate ratio adjusting unit that adjusts the flow rate ratio between the flow rate of the cooling water flowing into the radiator 61 and the flow rate of the cooling water flowing into the heater core 64. The operation of the three-way valve 65 is controlled by the control device 50.

In the present embodiment, when performing a chiller heat absorption amount increase control to increase the amount of heat absorbed from the chiller 20, the control device 50 controls the three-way valve 65 so that the blown air temperature TAV of the heater core 64 approaches the target air temperature TAO. Specifically, when the blown air temperature TAV of the heater core 64 is higher than the target air temperature TAO, the three-way valve 65 is controlled so that the flow rate ratio of the cooling water flowing into the radiator 61 increases and the flow rate ratio of the cooling water flowing into the heater core 64 decreases.

In such manner, the amount of heat dissipated from the radiator 61 is increased by the amount of heat absorbed from the chiller 20, thereby, in the above-described embodiment, it is possible to prevent the blown air temperature TAV of the indoor condenser 12 from exceeding the target air temperature TAO when performing the chiller heat absorption amount increase control.

Therefore, in the present embodiment, the same effects as those of the first embodiment are achievable.

In the present embodiment, the control device 50 increases the amount of heat discharged from the radiator 61 by increasing the flow rate of the cooling water in the heat dissipation cooling water circuit 60 flowing into the radiator 61 as the amount of heat absorption by the refrigerant in the chiller 20 increases.

In such manner, it is possible to reliably prevent the amount of heat dissipated into the air, which is the heat utilization target, from becoming excessive, as in the above-described embodiment.

The present disclosure is not limited to the embodiments described above, and various modifications can be made as follows within a scope not departing from the spirit of the present disclosure.

In the above-described embodiment, an example in which the refrigeration cycle device 10 is applied to a vehicle air conditioner has been described. However, the application of the refrigeration cycle device 10 is not limited to the above.

Application of the refrigeration cycle device 10 is not limited to vehicles. The refrigeration cycle device 10 may also be applied to stationary type air-conditioning devices or the like. For example, the refrigeration cycle device 10 may be applied to an air conditioner with a server temperature adjustment function that (i) cools a computer functioning as a server and (ii) also conditions the air in a room where the server is housed. Application of the refrigeration cycle device 10 is not limited to an air conditioner, and the refrigeration cycle device 10 may be applied to, for example, a hot water supply device that heats water for daily use as a target to be heated.

The refrigeration cycle device 10 may be an accumulator cycle device having an accumulator, or may be a receiver cycle device having a receiver.

The accumulator is a low-pressure side gas-liquid separation unit and, at the same time, a liquid storage unit (i) separating the refrigerant flowing out from the evaporator into gas and liquid and discharging the gas phase refrigerant to flow downstream, and (ii) storing the separated liquid phase refrigerant as excess refrigerant in the cycle. The receiver is a high-pressure side gas-liquid separation unit and, at the same time, a liquid storage unit (i) separating the refrigerant flowing out from the condenser into gas and liquid and discharging a part of the liquid phase refrigerant to flow downstream, and (ii) storing the remaining liquid refrigerant as excess refrigerant in the cycle.

In the above-described embodiments, an example in which R1234yf is employed as the refrigerant has been described, but the refrigerant is not limited to the above. For example, R134a, R600a, R410A, R404A, R32, R407C, and the like may also be employed as the refrigerant. Also, it is possible to employ mixed refrigerants formed from mixture of two or more refrigerants, out of the above, and the like.

In the above-described embodiment, an example of operation in which the air conditioning in the vehicle cabin is performed during the normal control and the cool-down expansion valve 16c is opened (i) to use the heat source device 32 as a heating source for the air or (ii) to cool the heat source device 32 has been described.

On the other hand, in case that there is no need, during the normal control, to use the heat source device 32 as a heating source for the air or to cool the heat source device 32, the cool-down expansion valve 16c may be closed. When switching from (i) the normal control in which the cool-down expansion valve 16c is closed to (ii) the chiller heat absorption amount increase control, the heat absorption amount of the refrigerant in the chiller 20 is increased by increasing the refrigerant flow rate toward the chiller 20, which is made possible by opening the cool-down expansion valve 16c.

In the first embodiment described above, the discharge capacity of the compressor 11 is controlled so that the evaporator temperature Te approaches the target evaporator temperature TEO. However, the discharge capacity of the compressor 11 may be controlled so that the blown air temperature TAV of the indoor condenser 12 (in other words, the blown air temperature from the indoor air conditioning unit 40) approaches the target air temperature TAO.

In other words, even in a refrigeration cycle device that controls the rotation speed of the compressor 11 so that the blown air temperature TAV (in other words, the temperature of the indoor condenser 12, which is a heat radiator) approaches the target air temperature TAO (in other words, a target heat radiator temperature), by performing the chiller heat absorption amount increase control, the temperature Te of the indoor evaporator 19 can be maintained without stopping the compressor 11.

In the above-described embodiment, as an example of the configuration of the refrigeration cycle device 10, an example in which a parallel arrangement of (i) the cooling expansion valve 16b and the indoor evaporator 19 and (ii) the cool-down expansion valve 16c and the chiller 20 are configured with respect to the refrigerant flow is described, but such a configuration is not a limiting one.

For example, (i) the cooling expansion valve 16b and the indoor evaporator 19 and (ii) the cool-down expansion valve 16c and the chiller 20 may be arranged in series with respect to the refrigerant flow.

That is, the refrigeration cycle device 10 may be configured (i) to have two sets of expansion valves and evaporators, and (ii) to be capable of controlling the amount of heat absorption of the refrigerant in the evaporator in one set, so that the temperature of the evaporator in the other set approaches the target evaporator temperature.

Although the present disclosure has been described with reference to embodiments, it is understood that the present disclosure is not limited to those embodiments or structures. The present disclosure includes various modifications or deformations within an equivalent range. Further, various combinations and forms, including one additional element or more, or less than one additional element, are also within the sprit and the scope of the present disclosure.

Features of a refrigeration cycle device disclosed in the description include follows.

### (Item 1)

A refrigeration cycle device includes:
a compressor (11) configured to suck, compress, and discharge a refrigerant;
a heat radiator (12, 18, 35, 36, 61, 63, 64) configured to radiate heat from the refrigerant discharged from the compressor;
a first pressure reduction unit (16b) and a second pressure reduction unit (16c) that are configured to reduce a pressure of the refrigerant heat-radiated in the heat radiator;
a first evaporator (19) configured to evaporate the refrigerant decompressed in the first pressure reduction unit;
a second evaporator (20) configured to evaporate the refrigerant decompressed in the second pressure reduction unit;
a compressor control unit (50a) configured to control operation of the compressor at a rotation speed equal to or higher than a minimum rotation speed (Nmin); and
a heat-absorption amount control unit (50c) configured to control an amount of heat absorption of the refrigerant in the second evaporator and to cause a temperature of the first evaporator to approach a target evaporator temperature, when a difference between the rotation speed of the compressor and the minimum rotation speed is within a predetermined range.

### (Item 2)

In the refrigeration cycle device according to Item 1,
in a case where the difference between the rotation speed of the compressor and the minimum rotation speed is within the predetermined range, (i) the heat-absorption amount control unit increases the amount of heat absorption of the refrigerant in the second evaporator when the temperature of the first evaporator is lower than the target evaporator temperature, and (ii) the heat-absorption amount control unit decreases the amount of heat absorption of the refrigerant in the second evaporator when the temperature of the first evaporator is higher than the target evaporator temperature, to bringing the temperature of the first evaporator closer to the target evaporator temperature.
   (item 3)

In the refrigeration cycle device according to Item 1 or 2, the heat-absorption amount control unit controls the amount of heat absorption of the refrigerant in the second evaporator by controlling a pressure reduction amount of the second pressure reduction unit, when the difference between the rotation speed of the compressor and the minimum rotation speed is within the predetermined range.

### (Item 4)

The refrigeration cycle device according to Item 3 further includes:
a heat-absorption heat medium circuit (30) in which a heat absorption heat medium circulates;
a heat supply unit (32) configured to supply heat to the heat absorption heat medium, wherein the second evaporator is configured to perform heat exchange between the refrigerant and the heat absorption heat medium to evaporate the refrigerant; and
a heat medium temperature control unit (50d) configured to control an amount of heat supplied from the heat supply unit to the heat absorption heat medium and to cause a temperature of the heat absorption heat medium to become equal to or higher than a predetermined value, when the difference between the rotation speed of the compressor and the minimum rotation speed is within the predetermined range.

### (Item 5)

The refrigeration cycle device according to Item 1 or 2 further includes a heat introduction unit (21, 30) configured to introduce a part of the heat of the refrigerant discharged from the compressor to the second evaporator. In this case, the heat-absorption amount control unit controls the amount of heat absorption of the refrigerant in the second evaporator by controlling the amount of heat of the refrigerant introduced from the compressor to the second evaporator.

### (Item 6)

In the refrigeration cycle device according to Item 5,
the heat introduction unit is a refrigerant introduction unit (21) configured to introduce a part of the refrigerant discharged from the compressor to the second evaporator, and
the heat-absorption amount control unit controls the amount of heat absorption of the refrigerant in the second evaporator by controlling the amount of heat of the refrigerant introduced from the compressor to the second evaporator.

### (Item 7)

In the refrigeration cycle device according to Item 5,
the heat radiator includes a refrigerant-heat medium heat exchanger (35) in which heat is exchanged between the refrigerant discharged from the compressor and the heat absorption heat medium,
the second evaporator is configured to exchange heat between (i) the heat absorption heat medium, heat-exchanged in the refrigerant-heat medium heat exchanger, and (ii) the refrigerant,
the heat introduction unit is a heat medium introduction unit (30) configured to introduce the heat absorption heat medium having heat-exchanged in the refrigerant-heat medium heat exchanger into the second evaporator, and
the heat-absorption amount control unit controls the amount of heat absorption of the refrigerant in the second evaporator by controlling a flow rate of the heat absorption heat medium introduced into the second evaporator.

### (Item 8)

In the refrigeration cycle device according to any one of Items 1 to 7, the heat radiator includes a heat utilization unit (12, 36, 64) configured to radiate heat to a heat utilization target, and a heat discharging unit (18, 61) configured to discharge heat to a target other than the heat utilization target. In addition, the refrigeration cycle device further includes a heat-discharging amount control unit (50b) configured to increase the amount of heat discharged by the heat discharging unit as the amount of heat absorption of the refrigerant in the second evaporator increases.

### (Item 9)

In the refrigeration cycle device according to Item 8, the heat discharging unit includes a discharging heat exchanger (18) configured to perform heat exchange of the refrigerant. The refrigeration cycle device further includes a heat-discharging pressure reduction unit (16a) configured to reduce a pressure of the refrigerant flowing into the discharging heat exchanger. In this case, the heat-discharging amount control unit increases the amount of heat discharged by the discharging heat exchanger by reducing the pressure reduction amount of the heat-discharging pressure reduction unit as the amount of heat absorption of the refrigerant in the second evaporator increases.

(item 10)

The refrigeration cycle device according to claim 8 further includes a heat-dissipation heat medium circuit (60) in which a heat dissipation heat medium circulates. In this case, the heat radiator includes a refrigerant-heat medium heat exchanger (63) in which heat is exchanged between the refrigerant and the heat dissipation heat medium, the heat utilization unit includes a first radiator (64) configured to radiate heat from the heat dissipation heat medium to the heat utilization target, the heat discharging unit includes a second radiator (61) configured to radiate heat from the heat dissipation heat medium to an object other than the heat utilization target, and the heat-discharging amount control unit increases the amount of heat discharged in the second radiator by increasing the flow rate of the heat dissipation heat medium flowing into the second radiator as the amount of heat absorption of the refrigerant in the second evaporator increases.

### (Item 11)

In the refrigeration cycle device according to any one of Items 1 to 10, the compressor control unit controls the rotation speed of the compressor to cause the temperature of the first evaporator to approach the target evaporator temperature.

### (Item 12)

In the refrigeration cycle device according to any one of Items 1 to 10, the compressor control unit controls the rotation speed of the compressor to cause the temperature of the heat radiator to approach a target heat radiator temperature.

What is claimed is:

1. A refrigeration cycle device comprising:
a compressor configured to suck, compress, and discharge a refrigerant;
a heat radiator configured to radiate heat from the refrigerant discharged from the compressor;
a first pressure reduction unit and a second pressure reduction unit that are configured to reduce a pressure of the refrigerant heat-radiated in the heat radiator;
a first evaporator configured to evaporate the refrigerant decompressed in the first pressure reduction unit;
a second evaporator configured to evaporate the refrigerant decompressed in the second pressure reduction unit; and
a controller including at least one of (i) a circuit and (ii) a processor with a memory storing computer program code executable by the processor, the controller being configured
to control operation of the compressor at a rotation speed equal to or higher than a minimum rotation speed, and
to control an amount of heat absorption of the refrigerant in the second evaporator and to cause a temperature of the first evaporator to approach a target evaporator temperature, when a difference between the rotation speed of the compressor and the minimum rotation speed is within a predetermined range, wherein
in a case where the difference between the rotation speed of the compressor and the minimum rotation speed is within the predetermined range, (i) the controller increases the amount of heat absorption of the refrigerant in the second evaporator when the temperature of the first evaporator is lower than the target evaporator temperature, and (ii) the controller decreases the amount of heat absorption of the refrigerant in the second evaporator when the temperature of the first evaporator is higher than the target evaporator temperature, to bringing the temperature of the first evaporator closer to the target evaporator temperature.

2. A refrigeration cycle device comprising:
a compressor configured to suck, compress, and discharge a refrigerant;
a heat radiator configured to radiate heat from the refrigerant discharged from the compressor;
a first pressure reduction unit and a second pressure reduction unit that are configured to reduce a pressure of the refrigerant heat-radiated in the heat radiator;
a first evaporator configured to evaporate the refrigerant decompressed in the first pressure reduction unit;
a second evaporator configured to evaporate the refrigerant decompressed in the second pressure reduction unit;
a compressor control unit configured to control operation of the compressor at a rotation speed equal to or higher than a minimum rotation speed; and
a heat-absorption amount control unit configured to control an amount of heat absorption of the refrigerant in the second evaporator and to cause a temperature of the first evaporator to approach a target evaporator temperature, when a difference between the rotation speed of the compressor and the minimum rotation speed is within a predetermined range, wherein
the heat-absorption amount control unit controls the amount of heat absorption of the refrigerant in the second evaporator by controlling a pressure reduction amount of the second pressure reduction unit, when the difference between the rotation speed of the compressor and the minimum rotation speed is within the predetermined range.

3. The refrigeration cycle device according to claim 2, further comprising:
a heat-absorption heat medium circuit in which a heat absorption heat medium circulates;
a heat supply unit configured to supply heat to the heat absorption heat medium, wherein the second evaporator is configured to perform heat exchange between the refrigerant and the heat absorption heat medium to evaporate the refrigerant; and
a heat medium temperature control unit configured to control an amount of heat supplied from the heat supply unit to the heat absorption heat medium and to cause a temperature of the heat absorption heat medium to become equal to or higher than a predetermined value, when the difference between the rotation speed of the compressor and the minimum rotation speed is within the predetermined range.

4. A refrigeration cycle device comprising:
a compressor configured to suck, compress, and discharge a refrigerant;
a heat radiator configured to radiate heat from the refrigerant discharged from the compressor;
a first pressure reduction unit and a second pressure reduction unit that are configured to reduce a pressure of the refrigerant heat-radiated in the heat radiator;
a first evaporator configured to evaporate the refrigerant decompressed in the first pressure reduction unit;
a second evaporator configured to evaporate the refrigerant decompressed in the second pressure reduction unit;
a compressor control unit configured to control operation of the compressor at a rotation speed equal to or higher than a minimum rotation speed;
a heat-absorption amount control unit configured to control an amount of heat absorption of the refrigerant in the second evaporator and to cause a temperature of the first evaporator to approach a target evaporator temperature, when a difference between the rotation speed of the compressor and the minimum rotation speed is within a predetermined range; and
a heat introduction unit configured to introduce a part of the heat of the refrigerant discharged from the compressor to the second evaporator, wherein
the heat-absorption amount control unit controls the amount of heat absorption of the refrigerant in the second evaporator by controlling the amount of heat of the refrigerant introduced from the compressor to the second evaporator,
the heat radiator includes a refrigerant-heat medium heat exchanger in which heat is exchanged between the refrigerant discharged from the compressor and the heat absorption heat medium,
the second evaporator is configured to exchange heat between (i) the heat absorption heat medium, heat-exchanged in the refrigerant-heat medium heat exchanger, and (ii) the refrigerant,
the heat introduction unit is a heat medium introduction unit configured to introduce the heat absorption heat medium having heat-exchanged in the refrigerant-heat medium heat exchanger into the second evaporator, and
the heat-absorption amount control unit controls the amount of heat absorption of the refrigerant in the second evaporator by controlling a flow rate of the heat absorption heat medium introduced into the second evaporator.

5. The refrigeration cycle device according to claim 1, further comprising
a refrigerant introduction line configured to introduce a part of the refrigerant discharged from the compressor to the second evaporator, and
the controller controls the amount of heat absorption of the refrigerant in the second evaporator by controlling the amount of heat of the refrigerant introduced from the compressor to the second evaporator.

6. A refrigeration cycle device comprising:
a compressor configured to suck, compress, and discharge a refrigerant;
a heat radiator configured to radiate heat from the refrigerant discharged from the compressor;
a first pressure reduction unit and a second pressure reduction unit that are configured to reduce a pressure of the refrigerant heat-radiated in the heat radiator;
a first evaporator configured to evaporate the refrigerant decompressed in the first pressure reduction unit;
a second evaporator configured to evaporate the refrigerant decompressed in the second pressure reduction unit;
a compressor control unit configured to control operation of the compressor at a rotation speed equal to or higher than a minimum rotation speed; and
a heat-absorption amount control unit configured to control an amount of heat absorption of the refrigerant in the second evaporator and to cause a temperature of the first evaporator to approach a target evaporator temperature, when a difference between the rotation speed of the compressor and the minimum rotation speed is within a predetermined range, wherein
the heat radiator includes a heat utilization unit configured to radiate heat to a heat utilization target, and a heat discharging unit configured to discharge heat to a target other than the heat utilization target, the refrigeration cycle device further comprising
a heat-discharging amount control unit configured to increase the amount of heat discharged by the heat discharging unit as the amount of heat absorption of the refrigerant in the second evaporator increases.

7. The refrigeration cycle device according to claim 6, wherein the heat discharging unit includes a discharging heat exchanger configured to perform heat exchange of the refrigerant, the refrigeration cycle device further comprising
a heat-discharging pressure reduction unit configured to reduce a pressure of the refrigerant flowing into the discharging heat exchanger, wherein
the heat-discharging amount control unit increases the amount of heat discharged by the discharging heat exchanger by reducing the pressure reduction amount of the heat-discharging pressure reduction unit as the amount of heat absorption of the refrigerant in the second evaporator increases.

8. The refrigeration cycle device according to claim 6 further comprising:
a heat-dissipation heat medium circuit in which a heat dissipation heat medium circulates, wherein the heat radiator includes a refrigerant-heat medium heat exchanger in which heat is exchanged between the refrigerant and the heat dissipation heat medium,
the heat utilization unit includes a first radiator configured to radiate heat from the heat dissipation heat medium to the heat utilization target,
the heat discharging unit includes a second radiator configured to radiate heat from the heat dissipation heat medium to an object other than the heat utilization target, and
the heat-discharging amount control unit increases the amount of heat discharged in the second radiator by increasing the flow rate of the heat dissipation heat medium flowing into the second radiator as the amount of heat absorption of the refrigerant in the second evaporator increases.

9. The refrigeration cycle device according to claim 1, wherein
the controller controls the rotation speed of the compressor to cause the temperature of the first evaporator to approach the target evaporator temperature.

10. The refrigeration cycle device according to claim 1, wherein
the controller controls the rotation speed of the compressor to cause the temperature of the heat radiator to approach a target heat radiator temperature.
